(19) United States
(12) Patent Application Publication
(10) Pub. No.: US 2023/0351902 A1
(43) Pub. Date: Nov. 2, 2023

(54) INFORMATION FUSION/OPERATION CONTROL DEVICE FOR ANTI-DRONE SYSTEM, ANTI-DRONE SYSTEM, AND OPERATION METHOD THEREOF

(71) Applicant: ELECTRONICS AND TELECOMMUNICATIONS RESEARCH INSTITUTE, Daejeon (KR)

(72) Inventors: Dong Woo LIM, Daejeon (KR); Kyu Min KANG, Daejeon (KR); Jae Cheol PARK, Daejeon (KR); Jin Hyung OH, Daejeon (KR); Su Na CHOI, Daejeon (KR); Sung Hyun HWANG, Daejeon (KR)

(21) Appl. No.: 18/140,738

(22) Filed: Apr. 28, 2023

(30) Foreign Application Priority Data
May 2, 2022 (KR) 10-2022-0054234

(51) Int. Cl. G08G 5/00

(52) U.S. Cl. CPC G08G 5/006; G08G 5/0069; F41H 11/02

(57) ABSTRACT

An information fusion and operation control device for anti-drone may include: a memory; and a processor configured to execute at least one instruction stored in the memory, the processor receives detection location information on a drone, receives identification location information on the drone, and generates neutralization area range information on the drone by fusing the detection location information and the identification location information.

### CROSS-REFERENCE TO RELATED APPLICATION(S)

This application claims priority to Korean Patent Applications No. 10-2022-0054234, filed on May 2, 2022, with the Korean Intellectual Property Office (KIPO), the entire contents of which are hereby incorporated by reference.

### BACKGROUND

### 1. Technical Field

Example embodiments of the present disclosure relate to a method of, in an anti-drone system composed of a detection device, an ID identification device, and a neutralization device, fusing location information between the detection device and the ID identification device so as to effectively neutralize a drone and controlling operation of the drone.

### 2. Description of Related Art

The contents described in this section merely provide background information on the present embodiment and do not constitute the related art.

As the use of drones expands globally, cases of adverse effects such as invasion of privacy due to illegal use, particularly illegal filming, and security threats to important facilities due to illegal invasion of important national facilities are continuously increasing. In addition, drone crashes or the like are also mentioned as one of the adverse effects of drones.

Even without professional knowledge, the general public can easily access small drones, and due to the nature of drones that can be controlled remotely, there is little burden on exposure of personal information, and thus there is a possibility that the drones will be abused for criminal activities.

There is an increasing demand for an anti-drone technology that prevents adverse cases of using drones in advance, and enables effective follow-up measures even when adverse cases occur.

Anti-drone devices can be largely classified into three types that are detection devices, ID identification devices, and neutralization devices. First, representative examples of detection devices for estimating the presence or absence and location of drones include radar devices, radio-frequency (RF) scanners, electro-optical/infrared (EO/IR) cameras, and the like. In addition, examples of devices for neutralizing illegal drones include jammers, net capture devices, and the like. However, with only detection and neutralization devices, it is possible to neutralize legal drones or it may be difficult to neutralize illegal drones due to failure of detection.

### SUMMARY Accordingly, example embodiments of the present disclosure are provided to substantially obviate one or more problems due to limitations and disadvantages of the related art.

An object of the present disclosure is to solve a problem of degradation in accuracy of neutralization due to amplification of errors occurring in a process of linking a detection device, an ID identification device, and a neutralization device.

In the present disclosure, the focus point for solving the problems of the related art is as follows. A neutralization device such as a jammer or the like does not require location information on each drone because the neutralization device simultaneously neutralizes areas within a specific range. However, in a process of fusing location information using sensor fusion, the location information on individual drones are estimated. Since the location information of the individual drones have an excessively higher resolution than a resolution at a level required by the neutralization device, an error amplification problem may occur.

Therefore, an object of the present disclosure is to solve the error amplification problem by performing location information fusion with a resolution at a level required by the neutralization device rather than a resolution of the location information of the ID identification device and/or the detection device.

According to a first exemplary embodiment of the present disclosure, an information fusion and operation control device for an anti-drone system may comprise: a memory; and a processor configured to execute at least one instruction stored in the memory, wherein the processor receives detection location information on a drone, receives identification location information on the drone, and generates neutralization area range information on the drone by fusing the detection location information and the identification location information.

In the generation of the neutralization area range information, the processor may fuse the detection location information and the identification location information on the basis of a resolution with which the drone is to be neutralized, and generate the neutralization area range information having a resolution with which the drone is to be neutralized.

The processor may receive the detection location information and a result of identifying the drone, and when the detection location information on the drone is present, but no identified drone is found, may perform a re-identification process for the drone on the basis of the detection location information. In the re-identification process, the processor may generate control information for an ID identification device so that available resources for identification of the drone are concentrated on the detection location information.

The processor may receive the identification location information and a result of detecting the drone, and when the identification location information on the drone is present, but no detected drone is found, may perform a re-detection process for the drone on the basis of the identification location information. In the re-detection process, the processor may generate control information for a detection device so that available resources for detection of the drone are concentrated on the identification location information.

In the generation of the neutralization area range information, the processor may calculate an error range of the detection location information, calculate an error range of the identification location information, and fuse the error range of the detection location information and the error range of the identification location information to generate the neutralization area range information.

In the generation of the neutralization area range information, the processor may calculate an error range of the detection location information, calculate an error range of the identification location information when the drone is not a target to be neutralized, and generate the neutralization area range information on the basis of the error range of the detection location information, wherein the neutralization area range information is generated so that the error range of the identification location information is not included in the neutralization area range information.

The processor may receive a result of identifying the drone and the identification location information from an ID identification device, receive a result of detecting the drone and the detection location information from a detection device, and transmit the neutralization area range information to a neutralization device.

When the detection location information on the drone is present, but no identified drone is found as the result of identifying the drone, the ID identification device may perform a re-identification process for the drone on the basis of the detection location information, wherein, in the re-identification process, the processor may generate control information for the ID identification device so that available resources for identification of the drone are concentrated on the detection location information, and transmit the control information for the ID identification device to the ID identification device, and when the identification location information on the drone is present, but no detected drone is found as the result of detecting the drone, the detection device may perform a re-detection process for the drone on the basis of the identification location information, wherein, in the re-detection process, the processor may generate control information for the detection device so that available resources for detection of the drone are concentrated on the identification location information, and transmit the control information for the detection device to the detection device.

According to a second exemplary embodiment of the present disclosure, an anti-drone system may comprise: an ID identification device configured to identify a drone and generate identification location information on the drone; and a detection device configured to detect the drone and generate detection location information on the drone, wherein neutralization area range information on the drone is generated by fusing the detection location information and the identification location information.

In the generation of the neutralization area range information, the detection location information and the identification location information may be fused based on a resolution with which the drone is to be neutralized, and the neutralization area range information having a resolution with which the drone is to be neutralized may be generated.

When the detection location information on the drone is present, but no identified drone is found, the ID identification device may perform a re-identification process for the drone on the basis of the detection location information, and in the re-identification process, available resources for identification of the drone may be concentrated on the detection location information.

When the identification location information on the drone is present, but no detected drone is found, the detection device may perform a re-detection process for the drone on the basis of the identification location information, and in the re-detection process, available resources for detection of the drone may be concentrated on the identification location information.

In the generation of the neutralization area range information, an error range of the detection location information may be calculated, an error range of the identification location information may be calculated, and the neutralization area range information may be generated by fusing the error range of the detection location information and the error range of the identification location information.

In the generation of the neutralization area range information, an error range of the detection location information may be calculated, an error range of the identification location information may be calculated when the drone is not a target to be neutralized, and the neutralization area range information may be generated based on the error range of the detection location information, wherein the neutralization area range information is generated so that the error range of the identification location information is not included in the neutralization area range information.

According to a third exemplary embodiment of the present disclosure, an operation method of an anti-drone system may comprise: identifying, by an ID identification device, a drone and generating identification location information on the drone; detecting, by a detection device, the drone and generating detection location information on the drone; and generating neutralization area range information on the drone by fusing the detection location information and the identification location information in the anti-drone system.

In the generating of the neutralization area range information, the neutralization area range information having a resolution with which the drone is to be neutralized may be generated by fusing the detection location information and the identification location information on the basis of a resolution with which the drone is to be neutralized.

When the detection location information on the drone is present, but no identified drone is found, the ID identification device may perform a re-identification process for the drone on the basis of the detection location information, and in the re-identification process, available resources for identification of the drone may be concentrated on the detection location information.

When the identification location information on the drone is present, but no detected drone is found, the detection device may perform a re-detection process for the drone on the basis of the identification location information, and in the re-detection process, available resources for detection of the drone may be concentrated on the identification location information.

The generating of the neutralization area range information may include: calculating an error range of the detection location information; calculating an error range of the identification location information; and generating the neutralization area range information by fusing the error range of the detection location information and the error range of the identification location information.

The generating of the neutralization area range information may include: calculating an error range of the detection location information; calculating an error range of the identification location information when the drone is not a target to be neutralized; and generating the neutralization area range information on the basis of the error range of the detection location information, wherein the neutralization area range information is generated so that the error range of the identification location information is not included in the neutralization area range information.

The present disclosure relates to a method of fusing location information of a detection device and an ID identification device of an anti-drone system and operation control thereof In the conventional method, a large error can occur due to the estimation of the location of the drone with unnecessarily high resolution, whereas, according to the present disclosure, location information can be fused according to a resolution at a level required in the neutralization process and thus the accuracy of neutralization can be significantly increased.

Further, according to the present disclosure, through the exchange of location information between the detection device and the ID identification device, the re-execution performance of detection and ID identification can be improved. In particular, according to the present disclosure, the re-execution of the detection and ID identification can be performed intensively on the corresponding location by exchanging the location information between the detection device and the ID identification device, and thus the performance of detection and ID identification can be improved.

According to the present disclosure, in the process of generating the neutralization area range information by fusing the detection location information of the detection device and the identification location information of the ID identification device in the anti-drone system, a method of estimating and fusing a range in which the drone can be present without determining the location of the drone as a specific point can be provided.

### BRIEF DESCRIPTION OF DRAWINGS

FIG. 1 is a conceptual diagram illustrating an overview of an anti-drone system according to an embodiment of the present disclosure.

FIG. 2 is an operation flowchart of a method of neutralizing an illegal drone performed by the anti-drone system according to the embodiment of the present disclosure.

FIG. 3 is a conceptual diagram illustrating a process of identifying an ID of a drone according to an embodiment of the present disclosure.

FIG. 4 is a conceptual diagram illustrating a process of re-identifying an ID of a drone according to an embodiment of the present disclosure.

FIG. 5 is a conceptual diagram illustrating a process of detecting a drone according to an embodiment of the present disclosure.

FIG. 6 is a conceptual diagram illustrating a process of re-detecting a drone according to an embodiment of the present disclosure.

FIG. 7 is a conceptual diagram illustrating a process of generating neutralization area range information according to an embodiment of the present disclosure.

FIG. 8 is a conceptual diagram illustrating a process of generating neutralization area range information according to another embodiment of the present disclosure.

FIG. 9 illustrates an internal structure of at least one of an information fusion and operation control device 150, an ID identification device 120, a detection device 130, and/or a neutralization device 140 constituting an anti-drone system according to an embodiment of the present disclosure, and is a physical block diagram that includes a processor, a memory, and peripheral devices thereof.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Recently, ID identification technology that can increase the accuracy of neutralization by remotely obtaining unique information (e.g., drone ID, location information, etc.) on a drone is being developed. Unlike a detection device, an ID identification device may identify a target or non-target to be neutralized on the basis of the obtained unique information, and thus more accurate neutralization is possible.

In order to effectively neutralize illegal drones, a linkage technology is needed to integrate a detection device, an ID identification device, and a neutralization device into one anti-drone system. As a representative example of the conventional linkage technology, there is sensor fusion technology. Specifically, a multi-drone anti-drone system using sensor fusion technology is a system that estimates locations of individual drones by fusing location information of a detection device and location information of an ID identification device in a sensor fusion method and then neutralizes the drones using the estimated locations as targets by performing a method such as jamming, net capture, or the like. However, in some cases, a large error may occur between detection location information of the detection device and identification location information of the ID identification device. In addition, in the process of estimating the locations of the drones using the sensor fusion technology from the detection location information and the identification location information including errors, the errors may be further amplified, resulting in degradation in accuracy of neutralization.

Meanwhile, even when the technology is known prior to the filing date of the present application, it may be included as part of the configuration of the present application as necessary, and this will be described herein without obscuring the spirit of the present disclosure. However, in describing the configuration of the disclosure of the present application, detailed descriptions of details that can be clearly understood by those skilled in the art as known technologies prior to the filing date of the present application may obscure the purpose of the present disclosure, and thus excessively detailed description of known technology will be omitted.

Hereinafter, exemplary embodiments of the present disclosure will be described in more detail with reference to the accompanying drawings. In order to facilitate overall understanding in the description of the present disclosure, like reference numerals in the drawings denote like components, and descriptions thereof will not be repeated.

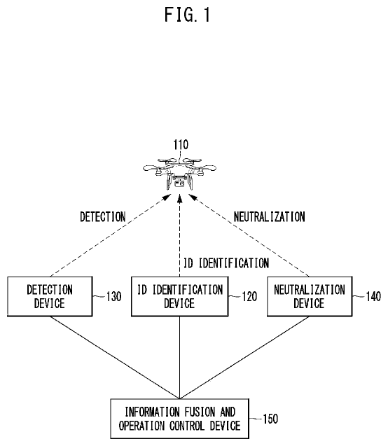

FIG. 1 is a conceptual diagram illustrating an overview of an anti-drone system according to an embodiment of the present disclosure.

Referring to FIG. 1, the anti-drone system may include a detection device 130, an ID identification device 120, a neutralization device 140, and an information fusion and operation control device 150. Examples of the detection device 130 include radar devices, radio-frequency (RF) scanners, electro-optical/infrared (EO/IR) cameras, and the like. Examples of the neutralization device 140 include jammers, net capture devices, and the like. The ID identification device 120 may be configured to obtain unique information on a drone 110 by performing wireless communication with the drone 110 on the ground.

Although the information fusion and operation control device 150 is illustrated in FIG. 1, the information fusion and operation control device 150 may not be formed separately according to another embodiment of the present disclosure. In another embodiment of the present disclosure, in case that the information fusion and operation control device 150 is not formed separately, the detection device 130, the ID identification device 120, and the neutralization device 140 may substitute for some or all of functions of the information fusion and operation control device based on the other embodiment.

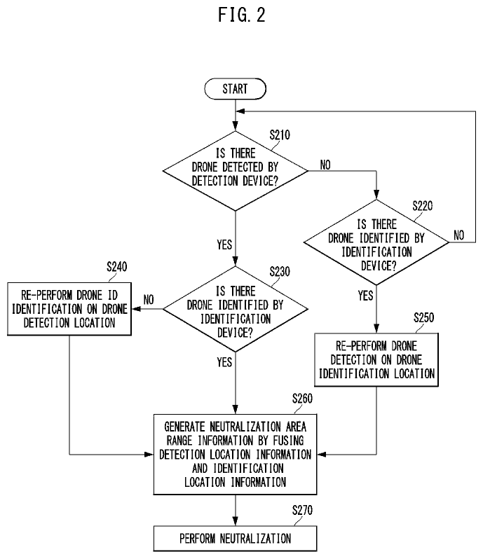

FIG. 2 is an operation flowchart of a method of neutralizing an illegal drone performed by the anti-drone system according to the embodiment of the present disclosure.

The method of FIG. 2 may be performed by the anti-drone system of FIG. 1, or may be performed by an embodiment in which the information fusion and operation control device 150 is not formed separately, which is not illustrated in FIG. 1. Referring to FIG. 2, when the process starts, it is determined whether there is a drone detected by the detection device 130 (S210), and then it is determined whether there is a drone identified by the ID identification device 120 (S220 and S230). As results of the determination of the detection device 130 and the ID identification device 120, the number of cases is a total of four, and the system operation for each case is as follows.

First, when there are no detected drone and no identified drone (S210 and S220), the process returns to the beginning.

Second, when there are both the detected drone and the identified drone (S210 and S230), neutralization area range information is generated by fusing detection location information and identification location information (S260). In this case, unlike the conventional sensor fusion technology, information on a range of neutralization areas is generated instead of generating locations of the individual drones. In such a method, it is not possible to obtain the location of the drone with a higher resolution as compared to the conventional sensor fusion method, but it is possible to obtain a range in which the drone is present with a smaller error.

In this case, when the method of FIG. 2 is performed by the embodiment of FIG. 1, operation S260 may be performed by the information fusion and operation control device 150. Meanwhile, when the method of FIG. 2 is performed by the embodiment in which the information fusion and operation control device 150 is not formed separately, operation S260 may be performed by at least one of the ID identification device 120, the detection device 130, and/or the neutralization device 140 alone or in combination.

Third, when there is a detected drone, but there is no identified drone (S210 and S230), the drone ID identification may be re-performed targeting the location of the detected drone (S240), and neutralization area range information is generated by fusing detection location information and identification location information (S260). In this case, in the process of re-performing the drone ID identification, the ID identification device 120 may concentrate available resources on the detection location, thereby further improving the performance of ID identification. Control information of the ID identification device 120 may be generated so that the ID identification device 120 may concentrate available resources on the detection location. The control information may be generated by at least one of the ID identification device 120, the detection device 130, the neutralization device 140, and the information fusion and operation control device 150.

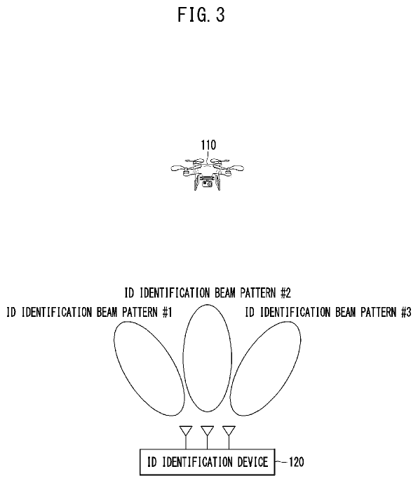

FIG. 3 is a conceptual diagram illustrating a process of identifying an ID of a drone according to an embodiment of the present disclosure.

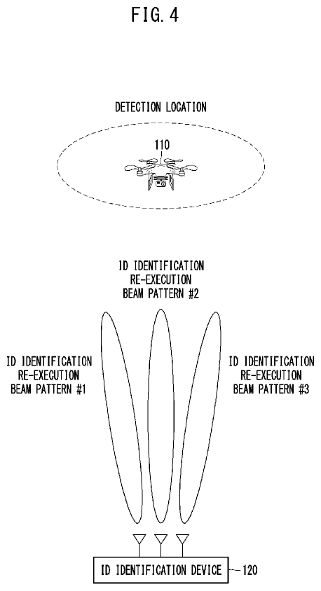

FIG. 4 is a conceptual diagram illustrating a process of re-identifying an ID of a drone according to an embodiment of the present disclosure.

For example, when the ID identification device 120 uses wireless communication technology, general ID identification may be performed as illustrated in FIG. 3, and the ID identification may be re-performed as illustrated in FIG. 4. In FIG. 3, the ID identification device 120 performs identification on surrounding areas with wide beams, and in FIG. 4, the ID identification device 120 performs identification intensively on detection locations with narrow beams. Since a higher signal-to-noise ratio may be obtained when narrow beams are used, the probability of successful communication for ID identification may be increased.

The formation of identification beam patterns #1 to #3 of FIG. 3 or 4 may be performed by the ID identification device 120 using detection location information of the detection device 130, or the information fusion and operation control device 150 may generate control information of the ID identification device 120 using the detection location information of the detection device 130, the control information may be transmitted to the ID identification device 120, and the formation of identification beam patterns #1 to #3 may be performed by the ID identification device 120 according to the control information.

Fourth, when there is an identified drone, but there is no detected drone (S210 and S220), the drone detection may be re-performed targeting a location of the identified drone (S250) and neutralization area range information is generated by fusing detection location information and identification location information (S260). In this case, in the process of re-performing the drone detection, the detection device 130 may concentrate available resources on the identification location, thereby further improving the performance of detection. Control information of the detection device 130 may be generated so that the detection device 130 may concentrate available resources on the identification location. The control information may be generated by at least one of the ID identification device 120, the detection device 130, the neutralization device 140, and the information fusion and operation control device 150.

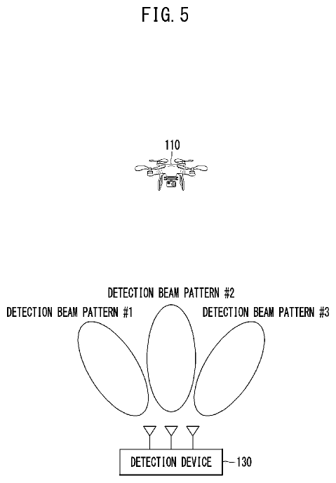

FIG. 5 is a conceptual diagram illustrating a process of detecting a drone according to an embodiment of the present disclosure.

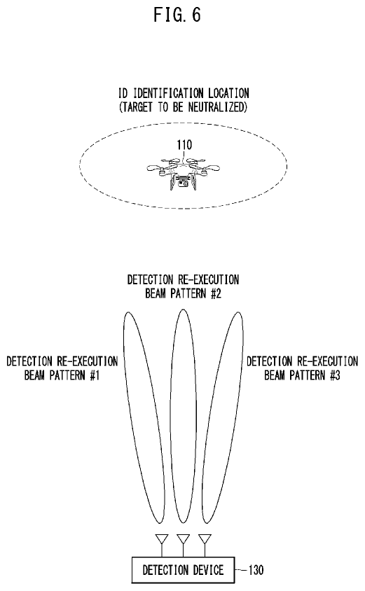

FIG. 6 is a conceptual diagram illustrating a process of re-detecting a drone according to an embodiment of the present disclosure.

For example, when the detection device 130 uses radar technology, general detection may be performed as illustrated in FIG. 5, and the detection may be re-performed as illustrated in FIG. 6. In FIG. 5, the detection device 130 performs detection on surrounding areas with wide beams, and in FIG. 6, the detection device 130 performs detection intensively on identification locations with narrow beams. Since a higher signal-to-noise ratio may be obtained when narrow beams are used, the detection probability of radar can be increased.

The formation of the detection beam patterns #1 to #3 of FIG. 5 or 6 may be performed by the detection device 130 using identification location information of the ID identification device 120, or the information fusion and operation control device 150 may generate control information of the detection device 130 using the identification location information of the ID identification device 120, the control information may be transmitted to the detection device 130, and the formation of identification beam patterns #1 to #3 may be performed by the detection device 130 according to the control information.

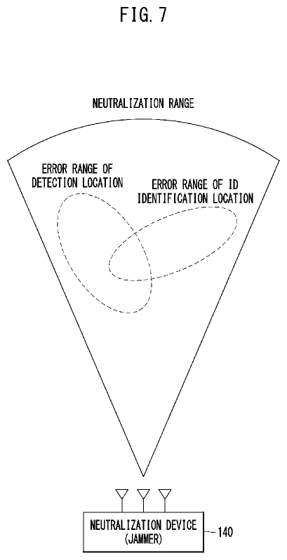

FIG. 7 is a conceptual diagram illustrating a process of generating neutralization area range information according to an embodiment of the present disclosure.

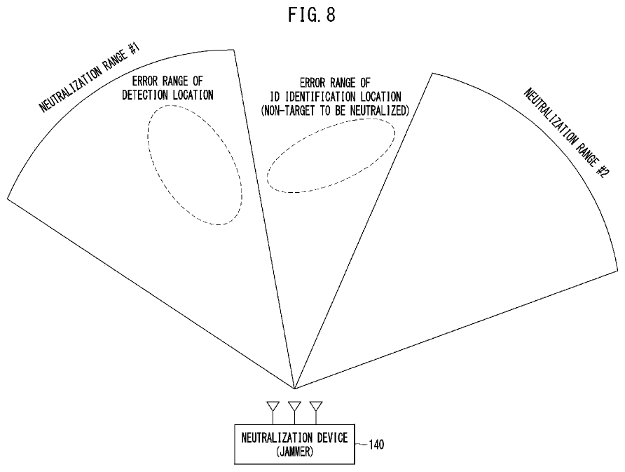

FIG. 8 is a conceptual diagram illustrating a process of generating neutralization area range information according to another embodiment of the present disclosure.

In the operation method of the anti-drone system of FIG. 2, the process of fusing the location information as in operation S260 is as follows. Each error range in which errors can occur around the detection location of the detection device 130 and the identification location of the ID identification device 120 may be derived. Next, a neutralization range is generated by fusing the error range of the detection location and the error range of the identification location. For example, when the neutralization device 140 uses a jammer, the method of each of FIGS. 7 and 8 may be used as a method of generating neutralization area range information by fusing the error range of the detection location and the error range of the identification location. When the identified drone is a target to be neutralized, a neutralization range may be generated for jamming by including both the error range of the detection location and the error range of the identification location as illustrated in FIG. 7. On the other hand, when the identified drone is not a target to be neutralized, a neutralization range may be generated for jamming by excluding the identification location error range as illustrated in FIG. 8.

After the detection location information and the identification location information are received by the information fusion and operation control device 150, the process S260 of setting the neutralization area range information may be performed in consideration of the error range of the detection location, the error range of the identification location, and the resolution of the jamming range or neutralization range of the neutralization device 140. Further, only after whether the identified drone is a target to be neutralized is considered, the neutralization range may be set in any one method of FIG. 7 or 8. Meanwhile, when the method of FIG. 2 is performed by an embodiment in which the information fusion and operation control device 150 is not formed separately, operation S260 may be performed by at least one of the ID identification device 120, the detection device 130, and/or the neutralization device 140 alone or in combination.

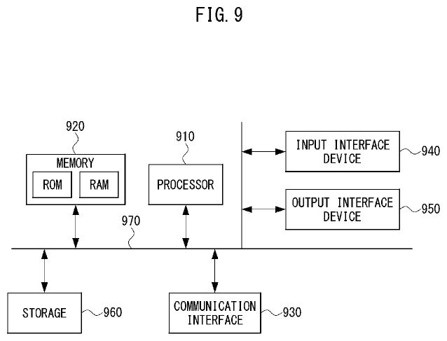

FIG. 9 illustrates an internal structure of at least one of an information fusion and operation control device 150, an ID identification device 120, a detection device 130, and/or a neutralization device 140 constituting an anti-drone system according to an embodiment of the present disclosure, and is a physical block diagram that includes a processor, a memory, and peripheral devices thereof.

Referring to FIG. 9, at least one of the information fusion and operation control device 150, the ID identification device 120, the detection device 130, and/or the neutralization device 140 constituting the anti-drone system includes a processor and a memory in which at least one instruction executed by the processor is stored. The at least one instruction may include an instruction (corresponding to operation S210) for the processor to detect a drone, an instruction (corresponding to operations S220 and S230) to identify the drone, an instruction to receive detection location information on the drone, an instruction to receive identification location information on the drone, and an instruction (corresponding to operation S260) to generate neutralization area range information on the drone by fusing the detection location information and the identification location information.

Further, depending on execution results of the instruction to detect the drone and the instruction to identify the drone, an instruction (corresponding to S240) to re-perform drone ID identification on the detection location of the drone and an instruction (corresponding to S250) to re-perform drone detection on the identification location of the drone may be included in the at least one instruction.

Further, an instruction (corresponding to S270) for the neutralization device 140 to perform neutralization after the neutralization area range information is generated may be included in the at least one instruction.

A processor 910 may include a central processing unit (CPU), a graphics processing unit (GPU), or a dedicated processor on which the methods according to the embodiments of the present disclosure are performed.

Each of a memory 920 and a storage device 960 may include at least one of a volatile storage medium and a non-volatile storage medium. For example, the memory 920 may include at least one of a read only memory (ROM) and a random-access memory (RAM).

Further, at least one of the information fusion and operation control device 150, the ID identification device 120, the detection device 130, and/or the neutralization device 140 constituting the anti-drone system may include a transceiver 930 that performs communication through a wireless network.

Further, at least one of the information fusion and operation control device 150, the ID identification device 120, the detection device 130, and/or the neutralization device 140 constituting the anti-drone system may further include an input interface device 940 that may receive a user instruction from a user or a manager, an output interface device 950 that may output a result of detecting the drone, detection location information, a result of identifying the drone, identification location information, whether the drone is a target to be neutralized, and/or neutralization area range information to the user or the manager, and a storage device 960 in which the result of detecting the drone, the detection location information, the result of identifying the drone, the identification location information, whether the drone is a target to be neutralized, and/or the neutralization area range information, and the like may be stored.

The respective components included in the at least one of the information fusion and operation control device 150, the ID identification device 120, the detection device 130, and/or the neutralization device 140 constituting the anti-drone system may be connected by a bus 970 to perform communication with each other inside the at least one of the information fusion and operation control device 150, the ID identification device 120, the detection device 130, and/or the neutralization device 140 constituting the anti-drone system.

The present disclosure relates to a method of fusing location information of the detection device 130 and the ID identification device 120 of the anti-drone system and operation control thereof. In the conventional method, a large error occurs due to the estimation of the location of the drone 110 with unnecessarily high resolution, whereas, according to the present disclosure, location information may be fused according to a resolution at a level required in the neutralization process and thus the accuracy of neutralization may be significantly increased.

Further, according to the present disclosure, through the exchange of location information between the detection device 130 and the ID identification device 120, the re-execution performance of detection and ID identification may be improved. In particular, according to the present disclosure, the re-execution of the detection and ID identification may be performed intensively on the corresponding location by exchanging the location information between the detection device 130 and the ID identification device 120, and thus the performance of detection and ID identification may be improved.

According to the present disclosure, in the process of generating the neutralization area range information by fusing the detection location information of the detection device 130 and the identification location information of the ID identification device 120 in the anti-drone system, a method of estimating and fusing a range in which the drone 110 may be present without determining the location of the drone 110 as a specific point may be provided. Since the drone 110 may always move and a moving speed is also fast, there is no guarantee that the drone 110 will be present at the specific point indicated by the detection location information and the identification location information even when neutralization is attempted. According to the present disclosure, by adding error information in which the mobility of the drone 110 is considered to the detection location information and the identification location information and generating neutralization area range information through fusing of the location information in which the error information is considered, it is possible to provide an effective neutralization means despite the mobility of the drone 110.

The at least one of the information fusion and operation control device 150, the ID identification device 120, the detection device 130, and/or the neutralization device 140 constituting the anti-drone system of the present disclosure may include, for example, a desktop computer, a laptop computer, a notebook computer, a smartphone, a tablet personal computer (PC), a mobile phone, a smart watch, smart glasses, an e-book reader, a portable multimedia player (PMP), a portable game machine, a navigation device, a digital camera, a digital multimedia broadcasting (DMB) player, a digital audio recorder, a digital audio player, a digital video recorder, a digital video player, a personal digital assistant (PDA), or the like, which is communicable.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An information fusion and operation control device for an anti-drone system, comprising:
a memory; and
a processor configured to execute at least one instruction stored in the memory,
wherein the processor is further configured to:
receive detection location information on a drone;
receive identification location information on the drone; and
generate neutralization area range information on the drone by fusing the detection location information and the identification location information.

2. The information fusion and operation control device of claim 1, wherein, in the generation of the neutralization area range information, the processor is further configured to:
fuse the detection location information and the identification location information on the basis of a resolution with which the drone is to be neutralized; and
generate the neutralization area range information having a resolution with which the drone is to be neutralized.

3. The information fusion and operation control device of claim 1, wherein the processor is further configured to:
receive the detection location information and a result of identifying the drone;
perform a re-identification process for the drone on the basis of the detection location information when the detection location information on the drone is present but no identified drone is found; and
generate control information for an ID identification device so that available resources for identification of the drone are concentrated on the detection location information in the re-identification process.

4. The information fusion and operation control device of claim 1, wherein the processor is further configured to:
receive the identification location information and a result of detecting the drone;
perform a re-detection process for the drone on the basis of the identification location information when the identification location information on the drone is present but no detected drone is found; and
generate control information for a detection device so that available resources for detection of the drone are concentrated on the identification location information in the re-detection process.

5. The information fusion and operation control device of claim 1, wherein, in the generation of the neutralization area range information, the processor is further configured to:
calculate an error range of the detection location information;
calculate an error range of the identification location information; and
fuse the error range of the detection location information and the error range of the identification location information to generate the neutralization area range information.

6. The information fusion and operation control device of claim 1, wherein, in the generation of the neutralization area range information, the processor is further configured to:
calculate an error range of the detection location information;
calculate an error range of the identification location information when the drone is not a target to be neutralized; and
generate the neutralization area range information on the basis of the error range of the detection location information, wherein the neutralization area range information is generated so that the error range of the identification location information is not included in the neutralization area range information.

7. The information fusion and operation control device of claim 1, wherein the processor is further configured to:
receive a result of identifying the drone and the identification location information from an ID identification device;
receive a result of detecting the drone and the detection location information from a detection device; and
transmit the neutralization area range information to a neutralization device.

8. The information fusion and operation control device of claim 7, wherein:
when the detection location information on the drone is present but no identified drone is found as the result of identifying the drone, the ID identification device is further configured to perform a re-identification process for the drone on the basis of the detection location information, wherein, in the re-identification process, the processor generates control information for the ID identification device so that available resources for identification of the drone are concentrated on the detection location information, and transmits the control information for the ID identification device to the ID identification device, and
when the identification location information on the drone is present but no detected drone is found as the result of detecting the drone, the detection device is further configured to perform a re-detection process for the drone on the basis of the identification location information, wherein, in the re-detection process, the processor generates control information for the detection device so that available resources for detection of the drone are concentrated on the identification location information, and transmits the control information for the detection device to the detection device.

9. An anti-drone system comprising:
an ID identification device configured to identify a drone and generate identification location information on the drone; and
a detection device configured to detect the drone and generate detection location information on the drone,
wherein neutralization area range information on the drone is generated by fusing the detection location information and the identification location information.

10. The anti-drone system of claim 9, wherein, in the generation of the neutralization area range information, the detection location information and the identification location information are fused based on a resolution with which the drone is to be neutralized, and the neutralization area range information having a resolution with which the drone is to be neutralized is generated.

11. The anti-drone system of claim 9, wherein, when the detection location information on the drone is present but no identified drone is found, the ID identification device is further configured to perform a re-identification process for the drone on the basis of the detection location information, and in the re-identification process, available resources for identification of the drone are concentrated on the detection location information.

12. The anti-drone system of claim 9, wherein, when the identification location information on the drone is present but no detected drone is found, the detection device is further configured to perform a re-detection process for the drone on the basis of the identification location information, and in the re-detection process, available resources for detection of the drone are concentrated on the identification location information.

13. The anti-drone system of claim 9, wherein, in the generation of the neutralization area range information, an error range of the detection location information is calculated, an error range of the identification location information is calculated, and the neutralization area range information is generated by fusing the error range of the detection location information and the error range of the identification location information.

14. The anti-drone system of claim 9, wherein, in the generation of the neutralization area range information, an error range of the detection location information is calculated, an error range of the identification location information is calculated when the drone is not a target to be neutralized, and the neutralization area range information is generated based on the error range of the detection location information, wherein the neutralization area range information is generated so that the error range of the identification location information is not included in the neutralization area range information.

15. An operation method of an anti-drone system, comprising:
identifying, by an ID identification device, a drone and generating identification location information on the drone;
detecting, by a detection device, the drone and generating detection location information on the drone; and
generating neutralization area range information on the drone by fusing the detection location information and the identification location information in the anti-drone system.

16. The operation method of claim 15, wherein, in the generating of the neutralization area range information, the neutralization area range information having a resolution with which the drone is to be neutralized is generated by fusing the detection location information and the identification location information on the basis of a resolution with which the drone is to be neutralized.

17. The operation method of claim 15, wherein, when the detection location information on the drone is present, but no identified drone is found, the ID identification device performs a re-identification process for the drone on the basis of the detection location information, and in the re-identification process, available resources for identification of the drone are concentrated on the detection location information.

18. The operation method of claim 15, wherein, when the identification location information on the drone is present, but no detected drone is found, the detection device performs a re-detection process for the drone on the basis of the identification location information, and in the re-detection process, available resources for detection of the drone are concentrated on the identification location information.

19. The operation method of claim 15, wherein the generating of the neutralization area range information comprises:
calculating an error range of the detection location information;
calculating an error range of the identification location information; and
generating the neutralization area range information by fusing the error range of the detection location information and the error range of the identification location information.

20. The operation method of claim 15, wherein the generating of the neutralization area range information comprises:
calculating an error range of the detection location information;
calculating an error range of the identification location information when the drone is not a target to be neutralized; and
generating the neutralization area range information on the basis of the error range of the detection location information, wherein the neutralization area range information is generated so that the error range of the identification location information is not included in the neutralization area range information.
